(19) United States
(12) Patent Application Publication
(10) Pub. No.: US 2017/0095112 A1
(43) Pub. Date: Apr. 6, 2017

(54) AUTOMATED BROILER WITH PRODUCT TEMPERATURE FEEDBACK SYSTEM

(71) Applicant: NIECO CORPORATION, Windsor, CA (US)

(72) Inventors: Matthew J. Baker, Santa Rosa, CA (US); Michael D. Janney, Santa Rosa, CA (US)

(21) Appl. No.: 15/286,523

(22) Filed: Oct. 5, 2016

Related U.S. Application Data
(60) Provisional application No. 62/237,444, filed on Oct. 5, 2015.

(51) Int. Cl. A47J 36/00; A47J 27/00; A47J 37/06

(52) U.S. Cl. CPC A47J 36/00; A47J 37/0688; A47J 27/002; A47J 27/004

(57) ABSTRACT

A cooking system, including a product loader for dispensing uncooked food product; a broiler/oven having an inlet end, a cooking chamber, a discharge end, a motorized conveyor system for conveying food through said broiler from said inlet end to said discharge end, and heating elements for heating and cooking food products in said cooking chamber. Disposed proximate the discharge end is a temperature sensor system including temperature sensors for measuring the internal temperature of the cooked food product. Readings from the temperature sensor system are sent to a system controller to evaluate and qualify food product as sufficient or insufficiently cooked. A discharge control system sends disqualified food product to a discard bin and qualified food product to a product holding bin.

### CROSS REFERENCES TO RELATED APPLICATIONS

The present application claims the benefit of U.S. Provisional Patent Application Ser. No. 62/237,444, filed 10/05/2015 (Oct. 5, 2015).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

Field of the Invention: The present invention relates generally to commercial broiler systems for the rapid cooking of food products, and more particularly to an automated broiler system that dispenses uncooked food product into a rapid cooking broiler and includes a number of system controls, as well as a product qualification/rejection feature, governed by system logic.

Discussion of Related Art including information disclosed under 37 CFR §§1.97, 1.98: To prepare certain foods, such as hamburger patties, sausages, hot dogs, and chicken and fish fillets, and the like, as well as their respective buns, high output commercial food purveyors (i.e., fast food restaurants) utilize broiler systems that rapidly and continually cook the food products. The systems typically comprise a housing having a horizontal conveyor for moving food product from an input end to an output end. During the cooking process the food passes between a number of spaced-apart cooking elements, typically either electric resistance elements or gas burners.

As may be readily appreciated, the profitability of utilizing such a system hinges on a number of factors, including the rapidity and efficiency with which the food product can be cooked, the minimization of energy and/or fuel utilized in cooking, the ease with which the system can be serviced and cleaned, the quality (and therefore desirability) of the cooked food products, and so forth.

Several rapid cooking broiler systems have been developed for use in the fast food industry, including those described in the following U.S. patents.

U.S. Pat. No. 4,936,286, to Baker, discloses a broiler system having at least two side-by-side broiling conveyors, and broiler units mounted adjacent to the conveyors extending across the combined widths of the two conveyors. To permit different heating conditions on the two conveyors while still permitting the broiler units to be interchangeable and made of interchangeable parts, a broiler unit is provided with a shield which blocks off the heated face of the broiler unit where the broiler unit faces one of the conveyors. The shield preferably carries a portion which extends towards the adjacent edges of two conveyors to prevent lateral heat radiation between the conveyors.

U.S. Pat. No. 4,188,868, to Baker et al, shows a broiler system having a food passageway restricted by baffles, including an entrance shield of heat-reflecting material formed as a fitting over the entrance burner housing and including a baffle sheet extending from the entrance burner housing through most of the gap toward the entrance opening, and an exit shield of similar heat-reflecting material formed as a fitting over the exit burner housing and having a baffle sheet extending from the exit burner housing through most of the gap toward the exit opening. In addition, there is an intermediate shield including a horizontal sheet of similar material resting on adjacent burner housings and having a vertical sheet depending from said horizontal sheet. The entrance shield, the exit shield and the intermediate shield define the upper limits of the passageway through the burner and tend to reflect heat away from the entrance and exit openings and to limit air circulation within and through the passageway.

U.S. Pat. No. 4,121,509, to Baker et al., teaches a housing having a passageway through which a continuous food conveyor operates, taking food products from an inlet end to an outlet end. Within the passageway the food products are exposed to infrared radiation from heaters, hot air blown from a fan through a supply duct and through groups of nozzles onto the patties, and steam or hot water vapor provided through the air supply. By using three different types of heat supply—direct infrared radiation, warm air, and water vapor—the system provides a quickly cooked food product having a relatively high moisture content.

U.S. Pat. No. 3,987,718 to Lang-Ree et al., discloses a hamburger patty and bun cooker having a frame supporting lower and upper heated platens. A product conveyor, typical of such systems, moves food product from the inlet to the outlet. At least one of the platens is provided with a low-friction layer between it and an advancing patty. The layer is constituted by jets of hot air discharged over the platen surface or by a Teflon-coated thin, metal foil sheet or by a Teflon-carrying thin, fiber glass sheet, the sheets being readily changeable. Bun portions for the individual patties are advanced on the same frame in paths parallel to the hamburger patties by comparable endless conveyors and are heated by individual platens on the frame as the bun portions advance.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein. In particular, none teach a commercial over/broiler system capable of evaluating the “doneness” of the cooked product, rejecting undercooked (“unqualified”) product, and automatically replacing the rejected product and restarting the cooking process, thereby ensuring food safety for consumers and dramatically reducing the exposure to potential liability of restaurant owners for selling food containing microbial pathogens.

### BRIEF SUMMARY OF THE INVENTION

In a first aspect, the present invention is an oven/broiler disposed between an automated uncooked product dispenser at its product input end and a cooked product dispenser at an output end. A user interface with input means sends signals to a controller that converts the signals into system commands. The controller also receives cooked product temperature feedback from the system and intelligently modulates the system to ensure that cooked products comply both with optimal flavor profiles and with health standards. Further, the controller works in cooperation with the temperature feedback system to remove and discard undercooked or otherwise unqualified cooked product and to then reload and replace the original order item.

Seen in another aspect, in some embodiments, the inventive system comprises a commercial broiler system having a freezer compartment coupled to the broiler, the freezer including a patty product magazine or cartridge with a motorized screw augur feed system, which separates the patties and feeds the patties onto a product loading chute, and operates at either a predetermined set (default) speed or at a speed modified according to product rejections and cooking speed feedback.

The system further includes a “made-to-order” broiler feeding and input system wherein the patty magazine feeds patties on a made-to-order basis from feed signals sent either by order takers with mobile connected devices or through the cash register upon payment for an order calling for a cooked product.

Next, the system includes a conveyor system including chain conveyors moving over flame stabilizer plates that facilitate the cooking of food while reducing the production of food waste, thereby increasing the mean time between cleaning cycles of the broiler systems, wherein the flame stabilizer plate uses a combination of radiant and forced convection heat. Some embodiments include forced air flame distribution shaped by forced air.

Moreover, embodiments of the include a temperature sensing and feedback system comprising a heat probe or lance which pierces product and takes internal temperatures of the product at the discharge end of the broiler, such that when an insufficient internal temperature is detected, the product conveyor reverses direction to discharge the product into a “reject” container. The product conveyor belt is staged and configured to allow for such reverse operation. Specifically, the product conveyor belt includes a terminal portion enabled for reverse operation for product “rejects” while the upstream portions of the conveyor continue such that the cooking of upstream products is not disrupted.

Finally, but not exhaustively, embodiments of the system include a controller with logic to manage all of the operations.

Embodiments of the present invention also provide a gas burner element that introduces directed and focused compressed air around burner flames to confine and direct the flames to optimal heating zones within the broiler, thus increasing burner efficiency

The broiler portion of the system may further include a novel flame plate design that facilitates the cooking of food while reducing the production of food waste thus increasing the meantime between cleaning cycles of the broiler systems. The flame plate is adapted for use in commercial broilers for cooking a variety of food products through the combination of radiant and forced convection heat. The flame plate may have a number of apertures to facilitate cleaning by allowing residual food matter to fall into a collection system. Residual food matter is primarily small bits and portions of the food being cooked on a conveyor system. In all configurations the flame plate enhances cooking and improves heat volume and heat distribution. The flame plate's mass provides a stabilizing effect to maintaining the oven temperature. The flame plate location also provides a barrier to physically block the transfer of residual food matter to other parts of the oven. Additionally, due to the flame plate's mass and operating temperature, some of the residual food matter is combusted. The net effect of including the flame plate in the broiler is to increase cooking capacity and mean time between cleaning intervals.

Other novel features characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1A is a front left perspective view of the inventive broiler system;

FIG. 1B is a front view in elevation thereof;

FIG. 1C is a front right perspective view thereof;

FIG. 1D is a detailed right front perspective view showing the uncooked product loading system;

FIG. 1E is a right side perspective view showing the product discharge portion of the broiler;

FIG. 2 is a highly schematic process flow chart of the automated broiler and temperature feedback system;

FIG. 3 is a highly schematic system flow chart showing the primary structural and operational components of the system;

FIG. 4, comprising FIGS. 4A-4B on separate sheets, is a hybrid data flow diagram of the system controller logic and process flow diagram of the inventive system;

FIG. 5A is a front left perspective view showing details of the auger motor and product cartridge that feeds uncooked product into the oven/broiler, shown unloaded (empty);

FIG. 5B is the same view showing the cartridge loaded with uncooked food product;

FIG. 5C is a side view in elevation thereof, showing a product patty positioned for loading down the product loading ramp at the upper end of the product loading cartridge;

FIG. 6A is an upper front left perspective view of a representative example of a broiler as used in the automated system;

FIG. 6B is a highly schematic cross-section rear view in elevation of the broiler shown in FIGS. 1A-1E;

FIG. 7 is a lower front perspective view of the airbox employed to introduce a focused curtain of air to direct burner heat and flames optimally onto the moving food product;

FIG. 8 is an upper right rear perspective view showing the terminal portion of the food product conveyor system and the temperature probes employed by the product temperature feedback system;

FIG. 9A is a right side (product discharge end) view showing a single discharge conveyor belt and a single temperature probe, the other removed to enable viewing other structure;

FIG. 9B is a schematic rear view in elevation showing a product patty loading onto the terminal portion of the product conveyor belt, moving into position for temperature testing;

FIG. 9C is the same view showing the product positioned under the temperature probe and the probe sensors inserted into the product;

FIG. 9D shows the temperature probe elevated off the product, at which time the temperature signal is being processed by the controller to determine whether to reject or qualify the product;

FIG. 9E shows the product being rejected as undercooked;

FIG. 10 is an upper front right perspective view of a freezer compartment for an alternative food cartridge dispenser for use with the food product conveyor system;

FIG. 11 is a top plan view thereof, showing in phantom the swing path of the freezer doors when hinged at the outer edges;

FIG. 12A is a front view in elevation thereof with the doors removed;

FIG. 12B is a right side cross-sectional view in elevation thereof taken along section lines 12B-12B of FIG. 12A;

FIG. 13A is a detailed cross-sectional side view in elevation thereof taken along sectional circle 13 of FIG. 12B, showing food product readied for dispensing; and

FIG. 13B is the same view showing product patties being dispensed out the food compartment slide at the rear of the freezer compartment.

### DETAILED DESCRIPTION OF THE INVENTION

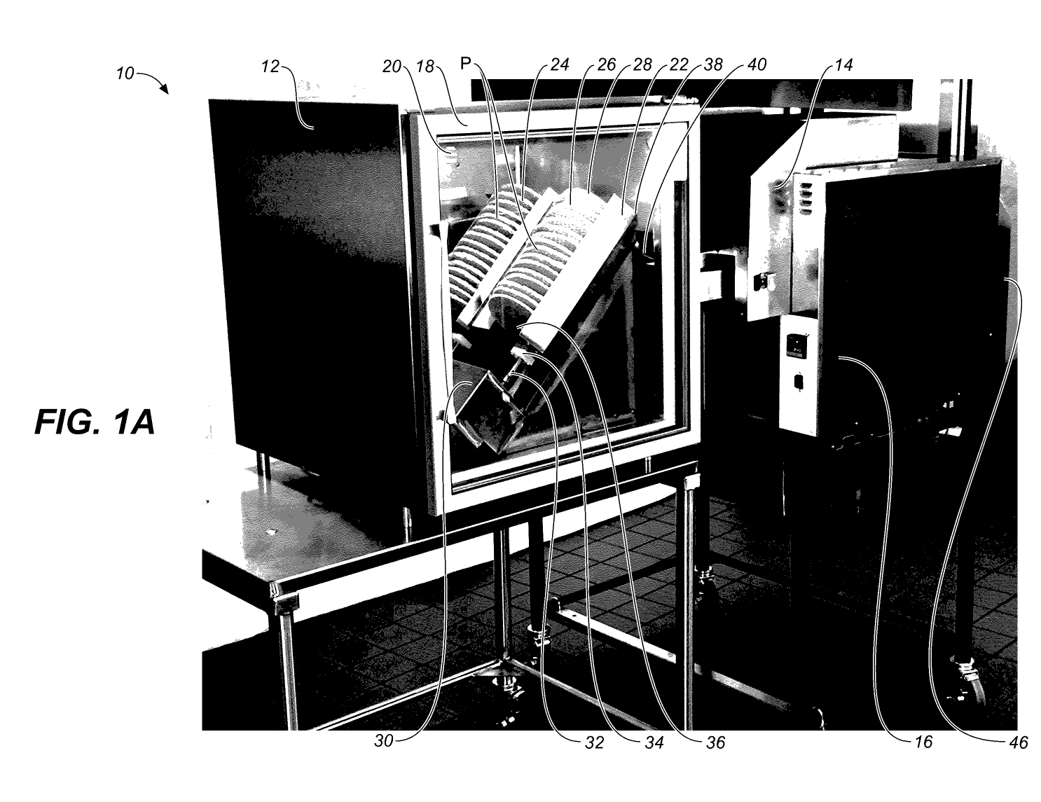

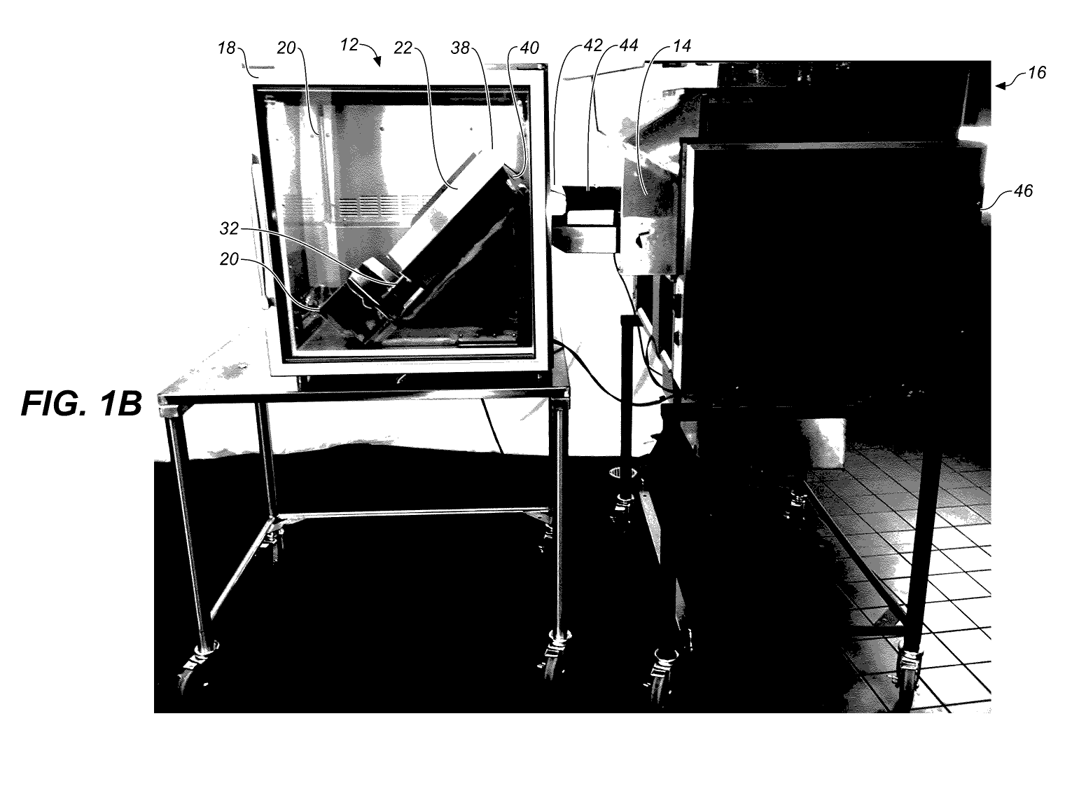

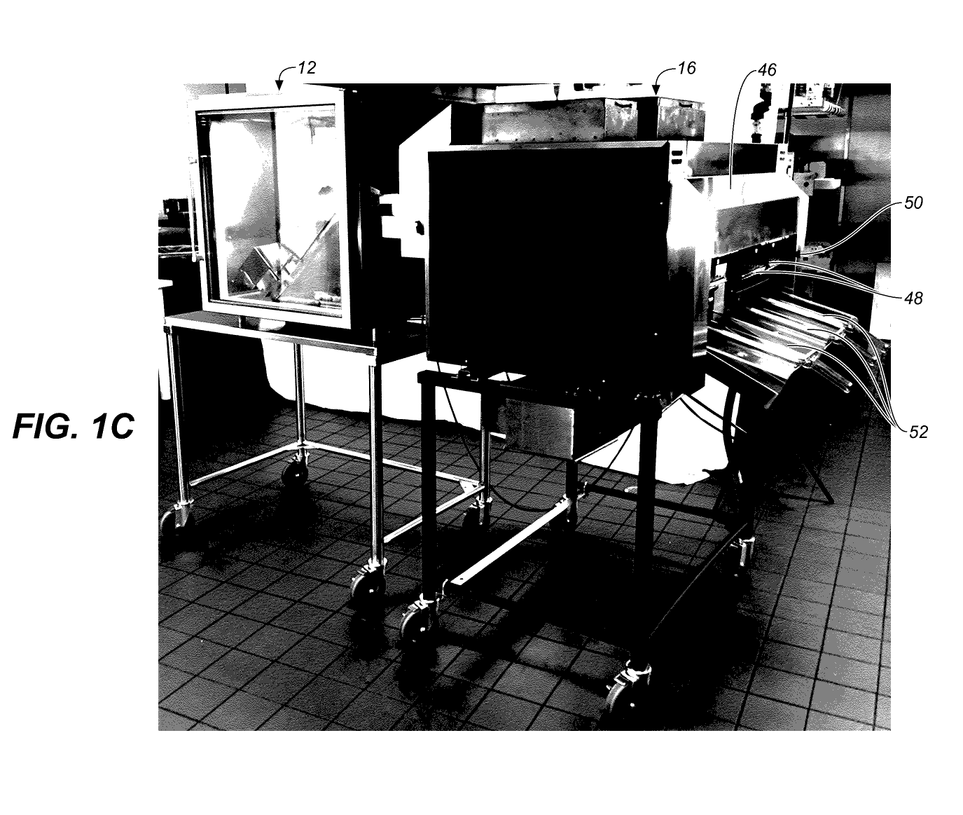

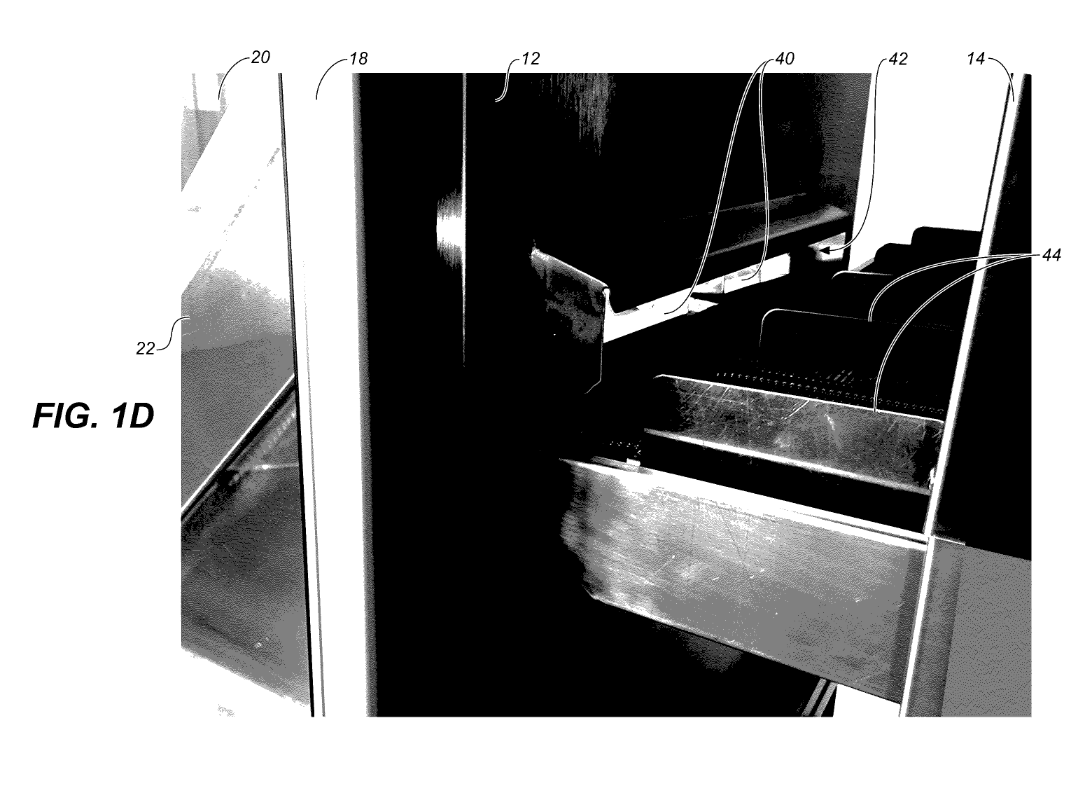

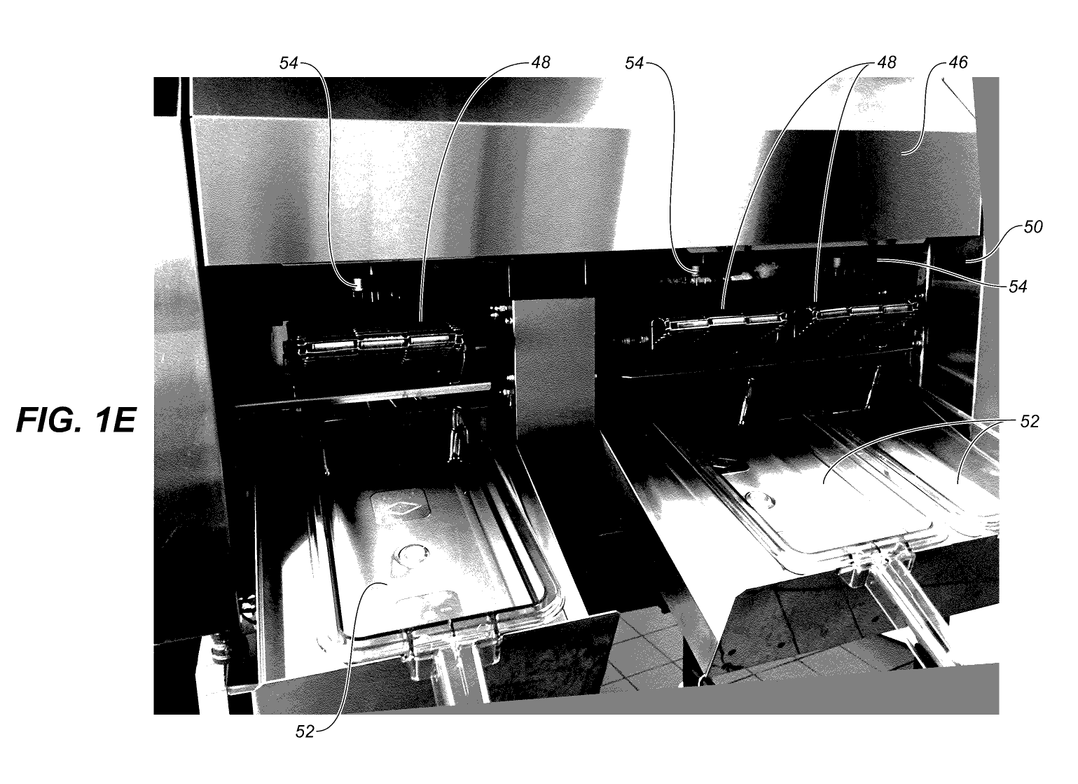

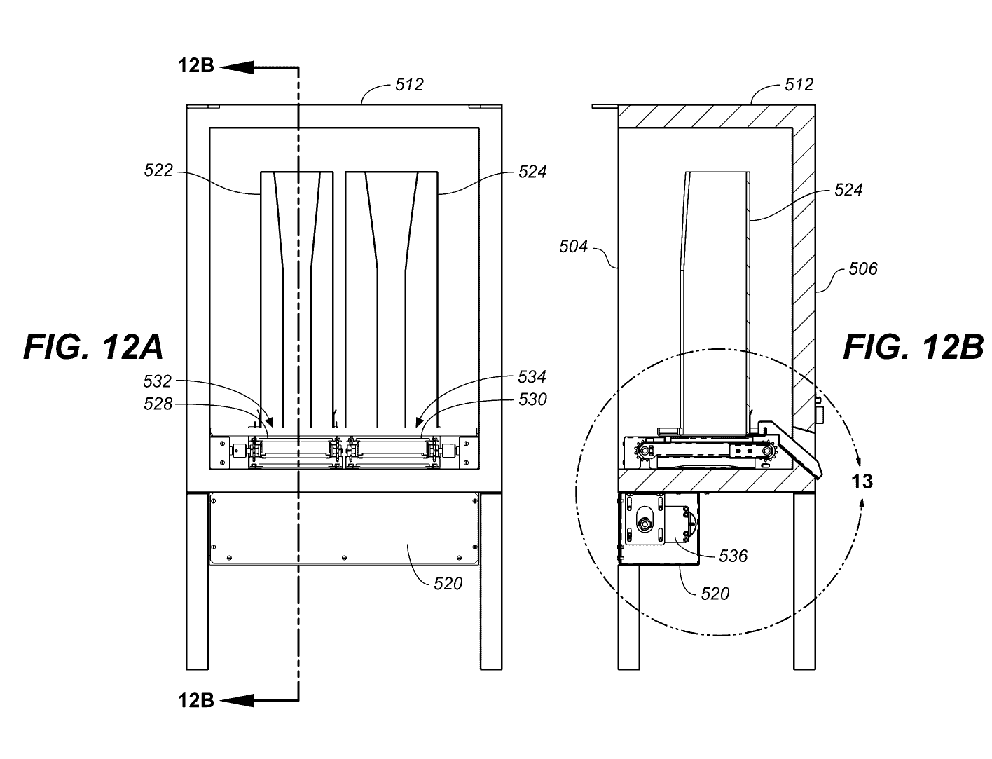

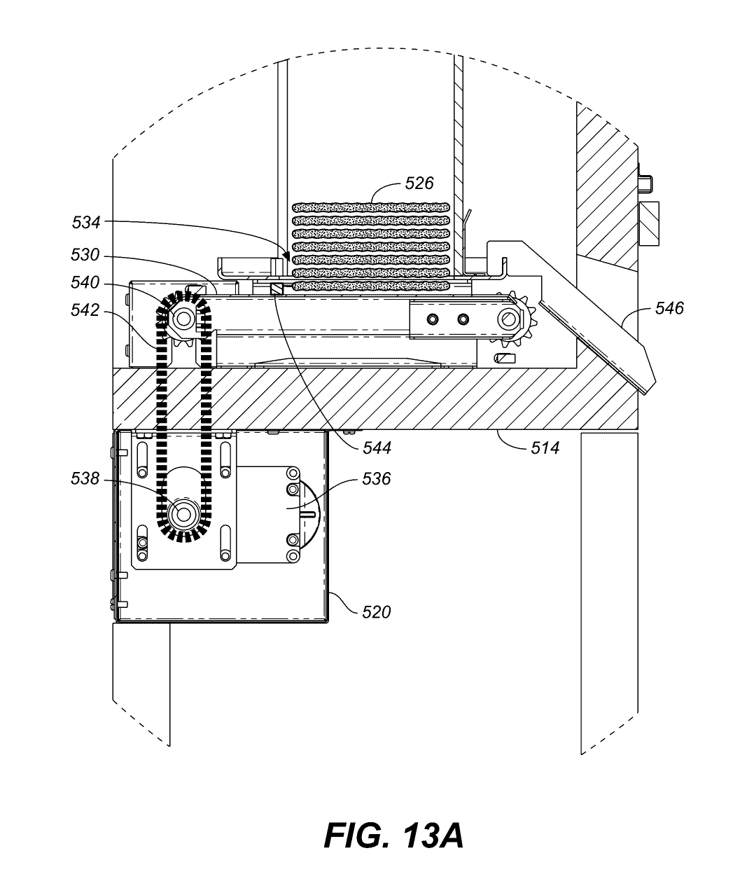

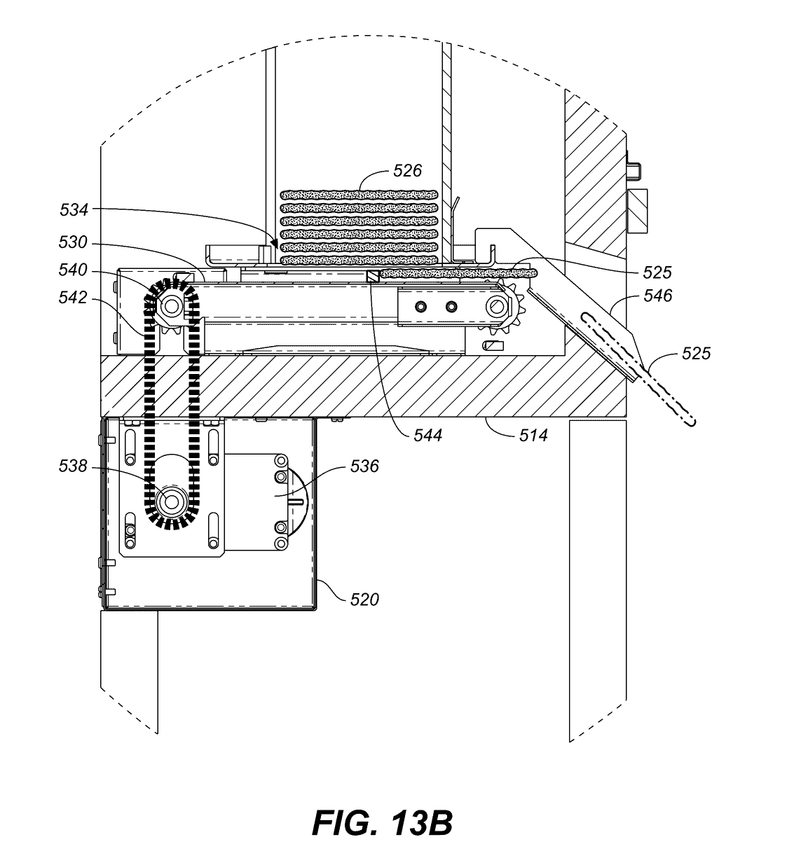

Referring to FIGS. 1A through 13B, wherein like reference numerals refer to like components in the various views, there is illustrated an automated commercial broiler having a product temperature feedback system, the entire system generally denominated 10 herein.

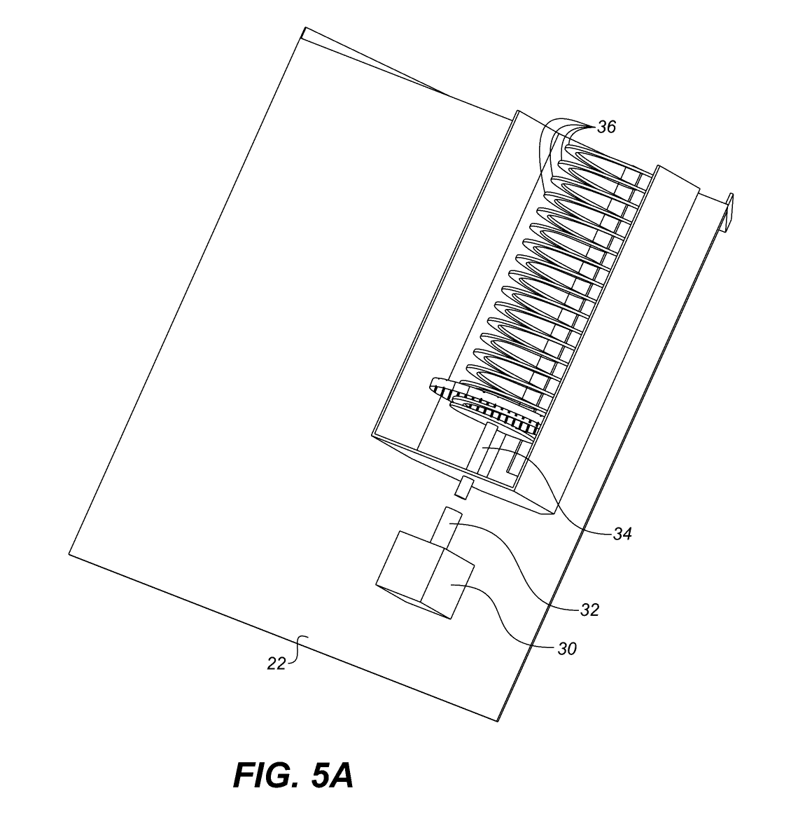

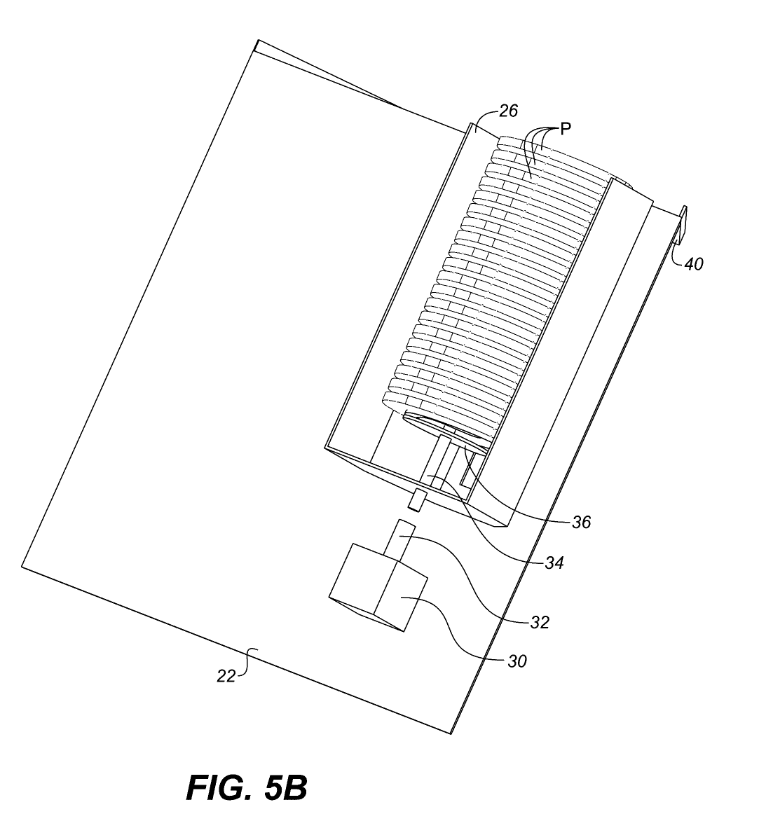

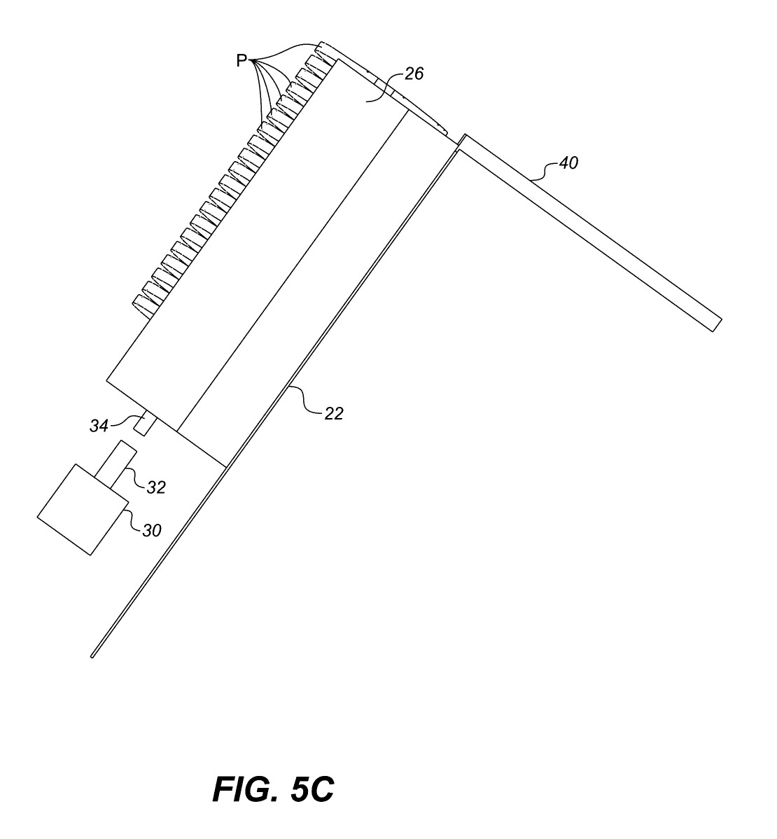

Referring first to FIGS. 1A-1E and 5A-5C, there is illustrated in a series of perspective views the major components included in the inventive automated broiler system. The refrigeration/freezer unit 12 is attached to an input end 14 of the broiler 16. The refrigeration/freezer unit 12 may be a box or any suitable configuration, and includes an access door 18, preferably having a transparent door window 20 for viewing the operation of the product loader 22 as well as the product content level in the uncooked food product magazines 24, 26.

In an embodiment, the product loader includes, as noted, uncooked product magazines, shown here with two, 24, 26, but which may number many more, and which hold uncooked food product 28 in an orientation (preferably spaced apart in a linear array) that permits the controlled introduction into the broiler of one discrete food product at a time from each uncooked product magazine. The loader further includes motors housed in an electric motor drive unit 30, each having a drive shaft 32 operatively coupled to an auger 34 having flights 36 onto which the product P is stacked in a spaced apart array. The upper ends 38 of the uncooked product magazines extend out and onto a loading chute 40 which extends into and at least partially through a broiler loading slot 42, configured such that the uncooked food product pieces slide onto the input end 44 of the broiler conveyor belt (described in detail below).

After being loaded into the broiler, each unit of food product is rapidly cooked in a highly efficient convection/radiant heating chamber, after which it is selectively discharged at the discharge end 46 of the broiler.

The discharge end of the broiler includes a terminal (exit) portion 48 of the conveyor belt system and an opening 50 through which food product passes before being dropped into a holding bin 52 (or a product reject bin, as discussed more fully below). Temperature sensors/probes 54 are disposed above each exit belt, and the probes move reciprocally and vertically up and down to pierce and penetrate the cooked food product to test its core doneness, thereby assuring both compliance with any applicable food safety and public health regulations and optimal temperature for known flavor preferences.

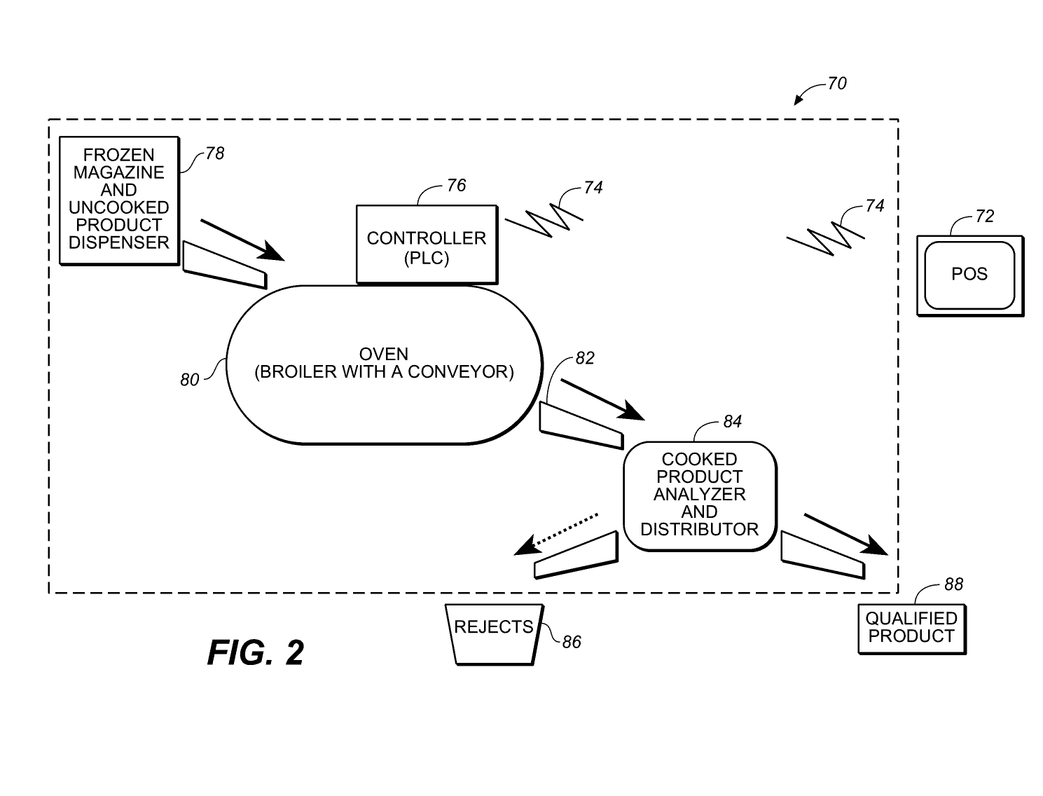

Looking next at FIG. 2, we see a highly schematic view of the overall broiler and product temperature feedback system, as well as a process flow chart of the system 70. Here is it seen that a point-of-sale device 72 having software tailored to the broiler system generates an instruction or start signal 74 to initiate a cooking cycle. The start signal is received by a system controller 76, such as a programmable logic controller (PLC). The POS device may be either wirelessly or in wired connection with the PLC. The PLC processes the start signal to generate a product dispenser output signal that turns on the product dispenser motor or motors in the product dispenser 78 so as to start a cooking cycle for the orders (start instructions) received. Product is dispensed to the oven/broiler 80, where it is cooked a predetermined amount of time at a tightly controlled temperature. When it reaches the discharge end 82 of the oven/broiler, a cooked product analyzer and dispenser 84 senses the position of the cooking product, inserts a temperature probe into the product, analyzes its doneness, and makes a determination as to whether to qualify or to reject the product. If the product is rejected, it is directed to a reject bin 86, and if the product is qualified, it is discharged into a qualified product holding bin 88.

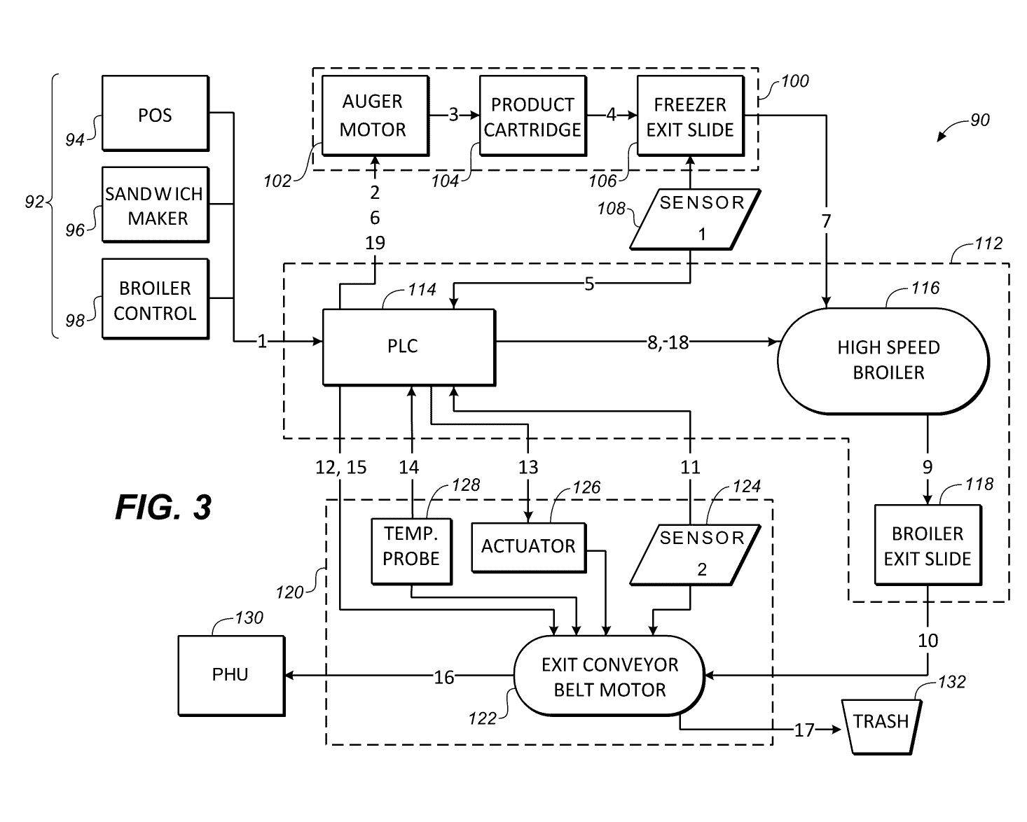

FIG. 3 provides a still more detailed view 90 of the system process, and shows particularly the functional blocks of the system components. Process start signals may be initiated at the input device 92 , which may include a POS 94, a sandwich maker 96, and a broiler control 98, all of which include input means (a touch screen, for instance) enabling a user to input instructions to commence a cooking cycle of one or more uncooked food products. The broiler control component may also include numerous specific broiler controls so that the purveyor may modify cooking cycle parameters—time, temperature, product loading spacing and sequencing, product qualify/reject parameters, and so forth.

The system next includes the freezer/refrigeration unit 100, which includes the auger and auger motor 102, the product cartridge 104, and the freezer exit slide 106, followed by a sensor 108 that detects and confirms that a unit of food product has been dispensed.

System logic resides in the broiler control unit 112, which includes a controller or PLC 114, which receives both the start signal input from the input device 92 and the signal from the sensor 108 confirming that a food product has been dispensed. The PLC is further in electronic communication with the high speed broiler 116 which conveys and cooks the food product according to control signals sent by the controller, until the product reaches the broiler exit slide 118, where it is then conveyed into the product temperature feedback unit 120.

Once in the product temperature feedback unit 120, the product is conveyed on an exit conveyor belt moved by an exit conveyor belt motor 122, which is electrically connected to a product sensor 124, which detects the leading edge of the product and sends a signal to the PLC to turn on an actuator 126 that drives down a temperature probe 128 disposed immediately above the cooked product, the probe having one or more pointed sensing elements sized and positioned to pierce and penetrate the food product to take a temperature reading at the depth requiring the most careful monitoring. If the temperature reading falls within a range of safe and suitably cooked products, the exit conveyor belt motor drives in a direction to discharge the product into a product holding unit 130; if not, then to a discard or trash receptacle 132.

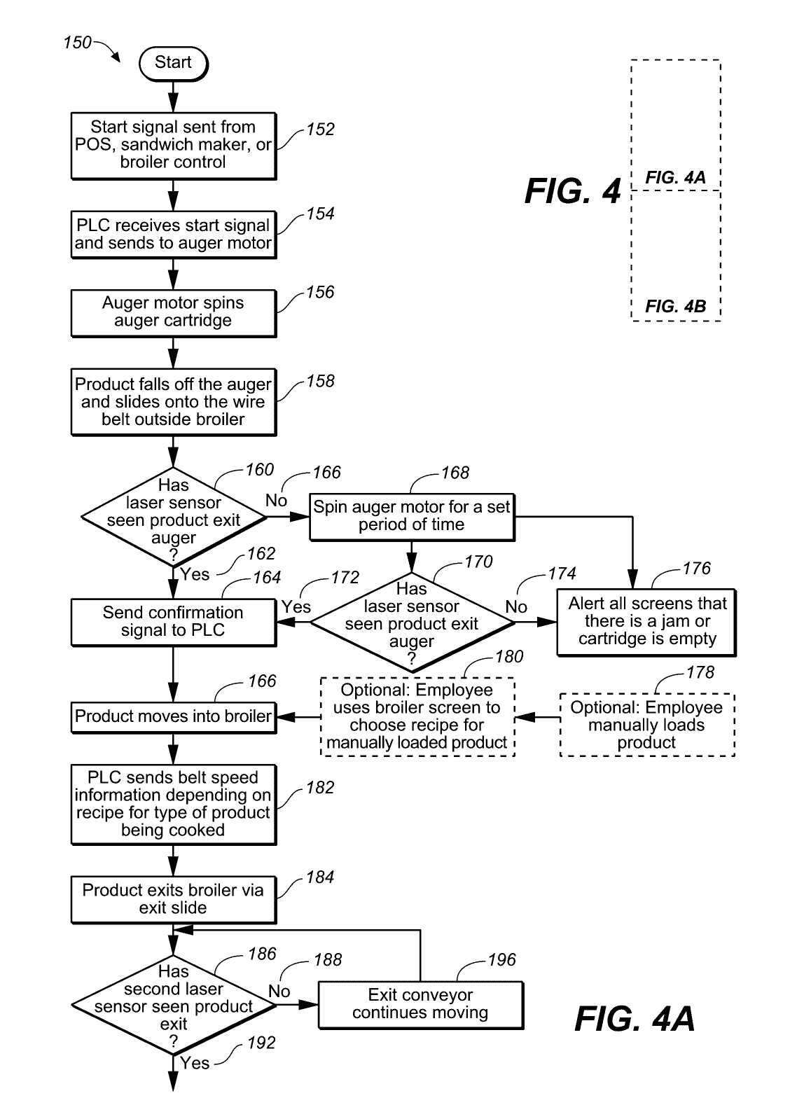

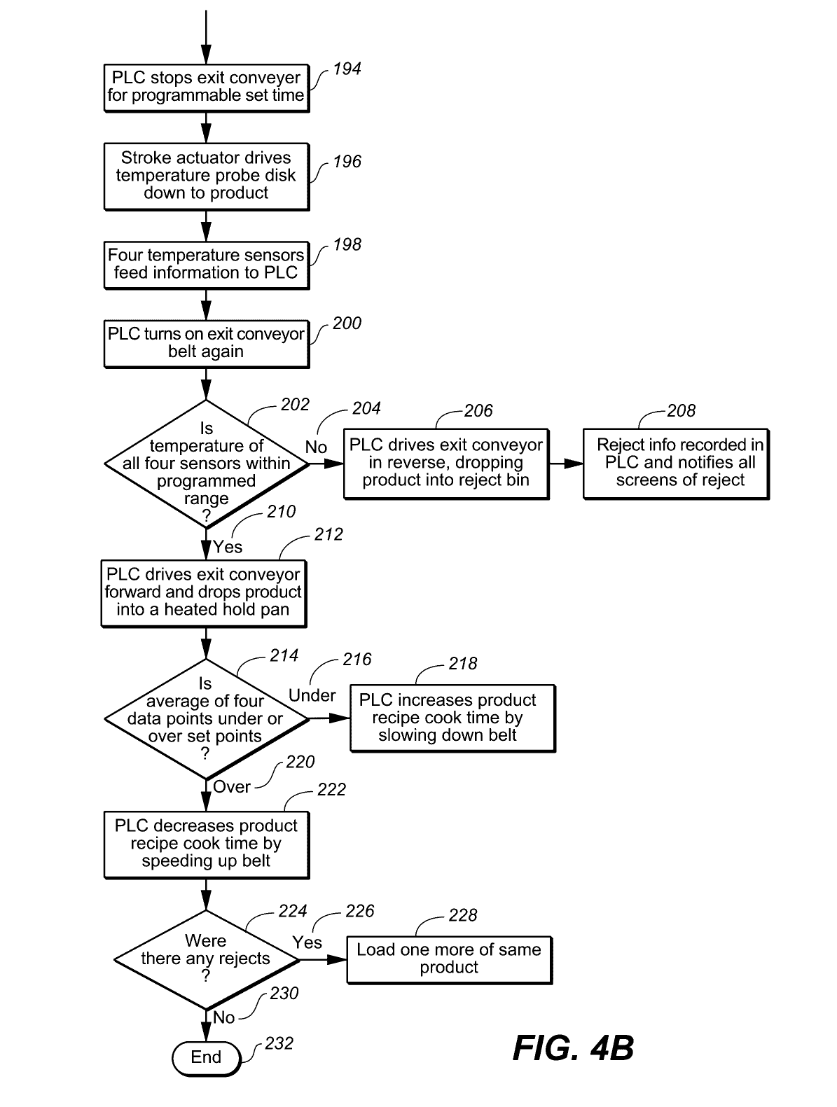

Referring next to FIG. 4, comprising sheets 8/22 and 9/22 of the drawings and divided into FIG. 4A and FIG. 4 B, there is shown a flow chart of the program logic 150 controlling the inventive automated broiler with product temperature feedback system.

At box 152 a start signal is sent from the Point of Sales system, which may be a screen having a user interface and located at the sandwich making table or on the broiler control screen at the broiler PLC or PCB. The signal may instruct that a cooking cycle be initiated for a single food product or a multiple of products to send of number of finished products to the cooked product holding bin.

At 154 the PLC receives and the signal and relays it to the auger motor, which may be located in the freezer/refrigeration unit, but which may also be located in a unit keeping food products at other than refrigerated temperatures.

At 156 the auger motor spins the auger cartridge or otherwise drives a food product dispenser motor to dispense the number of food products requested. When embodied as an auger drive, the pitch of the flights is tailored to the kind of product dispensed and may, for instance, be a 15-pitch auger, thus holding 15 products. A full revolution of the auger releases one product. It will be appreciated that the cartridge holding capacity is merely a matter of design and well within the skill of those in the art.

As a distinct advantage of the present invention, food product cartridges are easily removable for cleaning and maintenance, and extra cartridges can be pre-loaded and stored in a freezer unit for rapid replacement when a cartridge is depleted. No tools are needed to switch cartridges and couple the replacement with auger drive motor in the food dispensing unit.

When the auger has turned to dispense a product, the food product falls off the auger 158, which may occur under the force of gravity alone, and onto a chute or slide. The product slides or falls onto a stainless steel wire conveyor belt at the input side of the broiler, either entirely outside the broiler housing or immediately inside. A belt having a moving portion exposed outside the housing will enable restaurant employees to use the wire belt access to manually load products as needed. If product is manually loaded, thereby bypassing the automatic motorized food product dispenser, the employee may need to choose a particular recipe for a given product on the broiler control input (e.g., touchscreen).

Product dispensed automatically from the food product dispenser falls off the dispenser apparatus and onto the wire conveyor belt 158. A laser or other sensor is positioned at the dispenser exit and looks for product exiting the dispenser 160. If the sensor detects a dispensed product 162 it sends a signal to the PLC confirming that product has been loaded into the broiler and the product is moved into the broiler 164.

The PLC is programmed with a time for loading products and the time it should take for a product to exit the dispenser freezer; it correlates that time with the received signal. If there is an error in the timing and no product is otherwise detected 166, the PLC will continue spinning the dispenser motor 168 to dispense a food product unit, for instance in the event a pitch of the auger cartridge was not loaded at all or improperly loaded. The laser continues to scan for a product exiting the dispenser 170, and if it detects a product exiting the dispenser, it sends a confirmation signal, as at box 164. However, if after a predetermined time the laser still does not detect a product exiting the PLC 174, it sends an alert 176 for display on control screens indicating a possible jam or an empty cartridge 170.

In an embodiment, the freezer may include a “door open” detector such that when the freezer door is open, all commands to load food product are defeated and the drive unit motor cannot be operated. This prevents injuries due to motor operation when the freezer unit is being accessed.

As previously noted, an employee may manually load food product onto the conveyor belt 178, in which event the laser detector is bypassed, and cooking commands (e.g., a recipe) are then input by the employee 180 using the broiler control input screen.

When product is moves to the broiler 166 on the wire belt feeder, it enters the broiler housing for cooking by a novel high speed broiler which can cook frozen products (e.g., hamburger patties) in nearly half the time of conventional commercial broilers.

Depending on the product and/or recipe, the PLC controls belt speed by controlling the broiler conveyor belt motor 182.

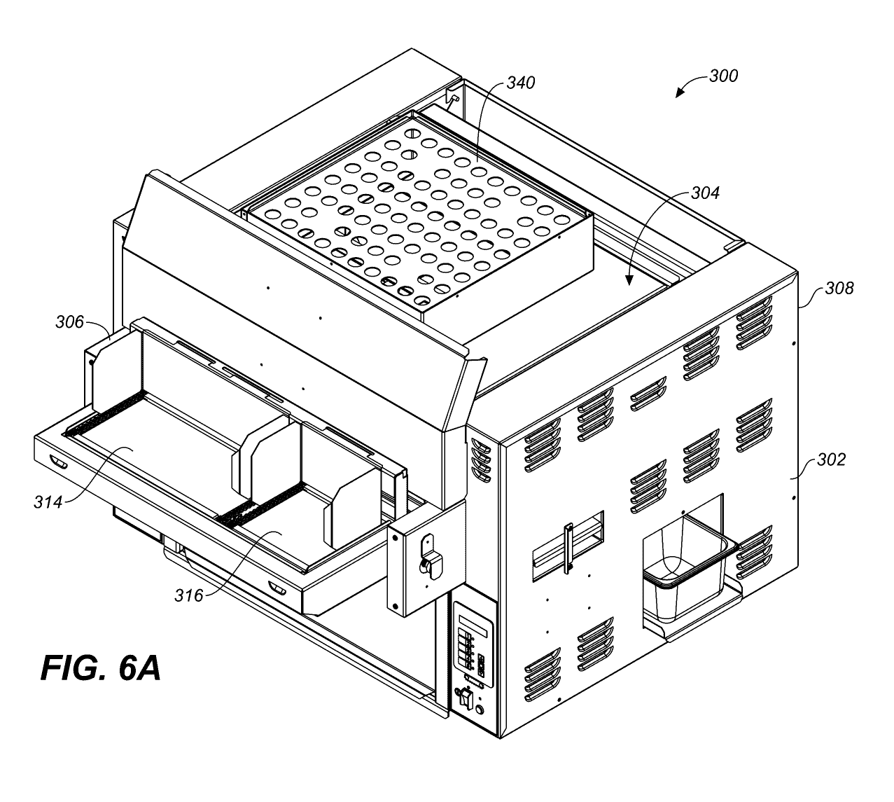

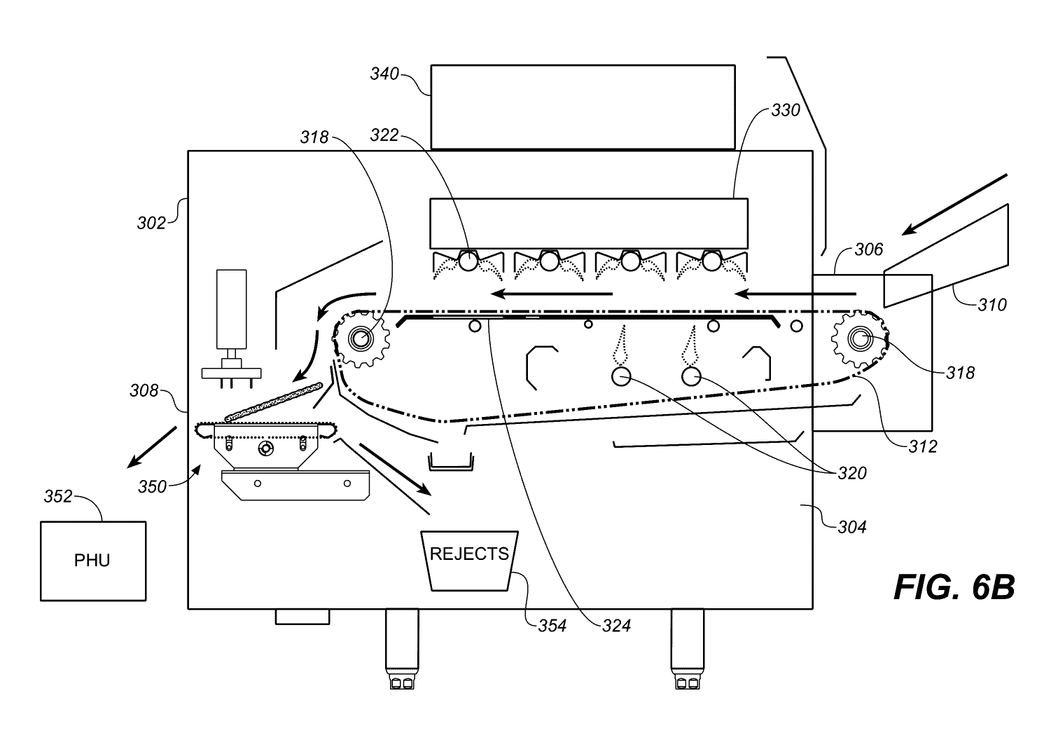

When the product has traversed the length of the cooking chamber in the broiler, it is stripped off the conveyor belt and exits the broiler 184 via an exit chute or slide. A laser or other sensor looks for and detects 186 the leading edge of the food product exiting the cooking chamber. The sensor is tripped by the presence of a product at a specific location in the product path. The PLC may use a delay trip (e.g., a 250 millisecond delay trip) to eliminate false trips. Once a trip occurs, the sensor signal is ignored for 15 seconds, which provides time for the HAACP (hazard analysis critical control point) process to occur. If food product is not detected 188, the exit conveyor simply continues forward movement 190. If it does detect food product on or after the exit chute 192, it stops the exit conveyor [see 350, FIG. 6B] for a predetermined time 194 and sends a signal to start a stroke actuator 196 and drive a temperature probe plate or foot having sensing elements (such as a plurality of thermocouple needles) molded into the body of the plate or foot and which pierce and penetrate the food product at a depth for a set time to get a core temperature reading. To ensure that a proper temperature is taken the probe includes support plugs on the thermocouple needle side to protect needle tips and to compress the food product slightly to avoid error caused by sending the needles into air or grease pockets.

Temperatures from each of the needles are continuously fed to the PLC 198. After set time from the initial product trip at the time the product exits the broiler, the PLC writes the four temperature data points to memory (along with the product name and current cook time, as well as the recipe and time of day), and then or concurrently analyzes the data. The PLC will turn the exit motor back on 200 in a direction that depends on the sensed temperature. The PLC evaluates 202 whether the sensed temperature is within a programmed range. If the data points from all sensors do not fall within the proper range 204, the PLC will reverse the motor 206 and send the product (either undercooked or overcooked) to a discard/reject bin [see 354, FIG. 6B], record the rejection information, and send a notification to the display screens 208. Loop logic in the PLC determines the temperature probe positions upon machine start up and re-positions the probes to an “origin” after each HAACP process so as to ensure that there is no floating of the actuator stepper motor. If all data points of the product fall within the programmed temperature range 210, for example, 150-180° F., the PLC drives the exit conveyor forward 212, dropping the cooked food product into a heated product holding unit (“PHU”) or bin [see 352, FIG. 6B].

If the average of the four data points, computed by PLC at 214, falls under a programmable dynamic set point 216, for example 155° F., the PLC increases product recipe cook time by slowing down the cook belt 218. If the average of the four data points is above a set point 220, for example 175° F., the PLC increases the recipe cook time by speeding up the cook belt 222. Since the PLC is programmed for a particular food product, or when a user manually loads a product and overrides automated loading, the PLC has reject and dynamic limits for different products, as part of each recipe.

Finally, the system looks for and notes the occurrence of rejects 224 to ensure the proper number of final cooked products is achieved, and if there is a reject 226, the PLC prompts another loading of the same product 228 to ensure it cooks the needed amount of product. If not 230, the complete process flow has been achieved 232.

FIGS. 6A-6C show the novel broiler system 300 employed in the present invention. As with known systems, the broiler/oven includes a housing 302 defining a cooking chamber 304 with a product input side 306 and product discharge side 308. Alternative configurations to achieve the same functional ends are contemplated in the description herein and fall within the scope of the invention. For instance, the broiler/oven could be configured with coincident input and discharge ends, which may be accomplished through simple modifications of the product conveyor system or discharge chutes.

Product from the uncooked product dispenser are moved to the input side of the broiler and onto the loading platform 310, where it is placed onto the wire conveyor belts 312, in each of the belt lanes, two being shown in FIG. 6A, 314, 316, driven by one or more drive shafts 318. Lower and upper burners 320, 322 provide both direct and indirect radiant heat to the food product moving through the cooking chamber. The radiant heat is dramatically increased by the inclusion of flame stabilizer plates 324 immediately under the wire conveyor belts in each lane of the cooking chamber. The flame stabilizer plates include a number of apertures to facilitate cleaning by allowing residual food matter to fall into a collection system. Small bits of residual food matter may collect on and under the conveyor belts. The flame stabilizer plates enhance cooking and improve heat volume and distribution. The flame stabilizer plate mass provides a stabilizing effect to maintaining the oven temperature with added radiant cooking. The flame stabilizer plates are located so as to provide a physical barrier that blocks the passage of residual food matter to other parts of the oven through the conveyor belt. Additionally, due to the flame stabilizer plate mass and operating temperatures, some of the residual food matter is combusted. The net effect of including the flame stabilizer plate in the oven is to increase cooking capacity and to reduce the mean time between broiler cleaning intervals.

Cooking efficiency is further enhanced by the use of a low pressure compressed air system that provides air to an air plenum 330 disposed above the upper gas burner elements, and each having a wave-shaped corrugated bottom panel 332 with parallel arrays of air outlet ports 334 that straddle the gas burner elements and create a curtain of forced air that drives heat and flame downwardly and toward the moving food product. Air from a compressor is introduced into an upper plenum 336, and then passes into a lower plenum through air holes 338 configured to provide air at a low but steady pressure suited to flame and heat control. The air then passes through the parallel arrays of holes 334 to push curtains of air down from the sides of the burner elements. This tightly focuses heat on the passing food product.

At the same time, heat from lower burners 320 is directed up into the flame stabilizer plates, which each are large masses of stainless steel, and when fully heated radiate heat up into the product passing overhead on the wire conveyor belts. Ignition of residual food bits and grease is promoted, thereby reducing clean up and solid waste. At the same time, smoke and gas exhaust are filtered and scrubbed by an exhaust filter and catalytic converter 340.

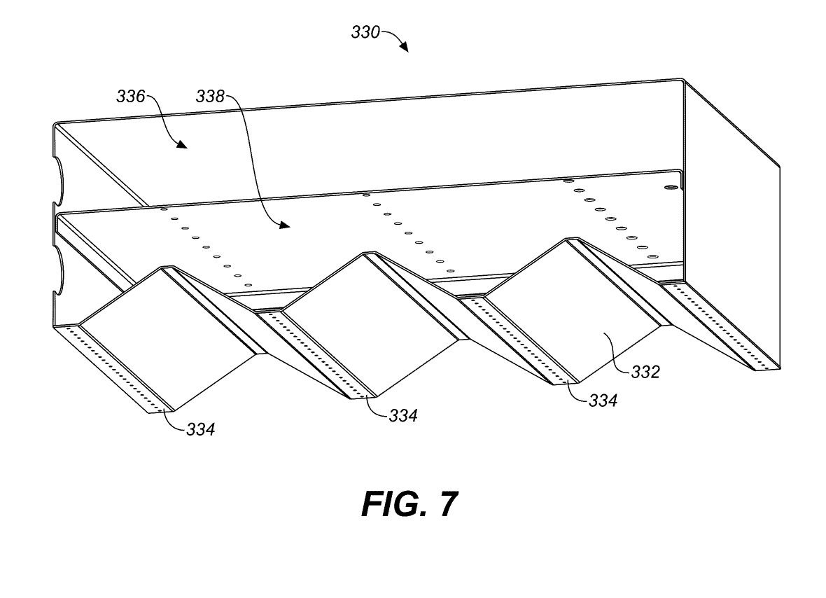

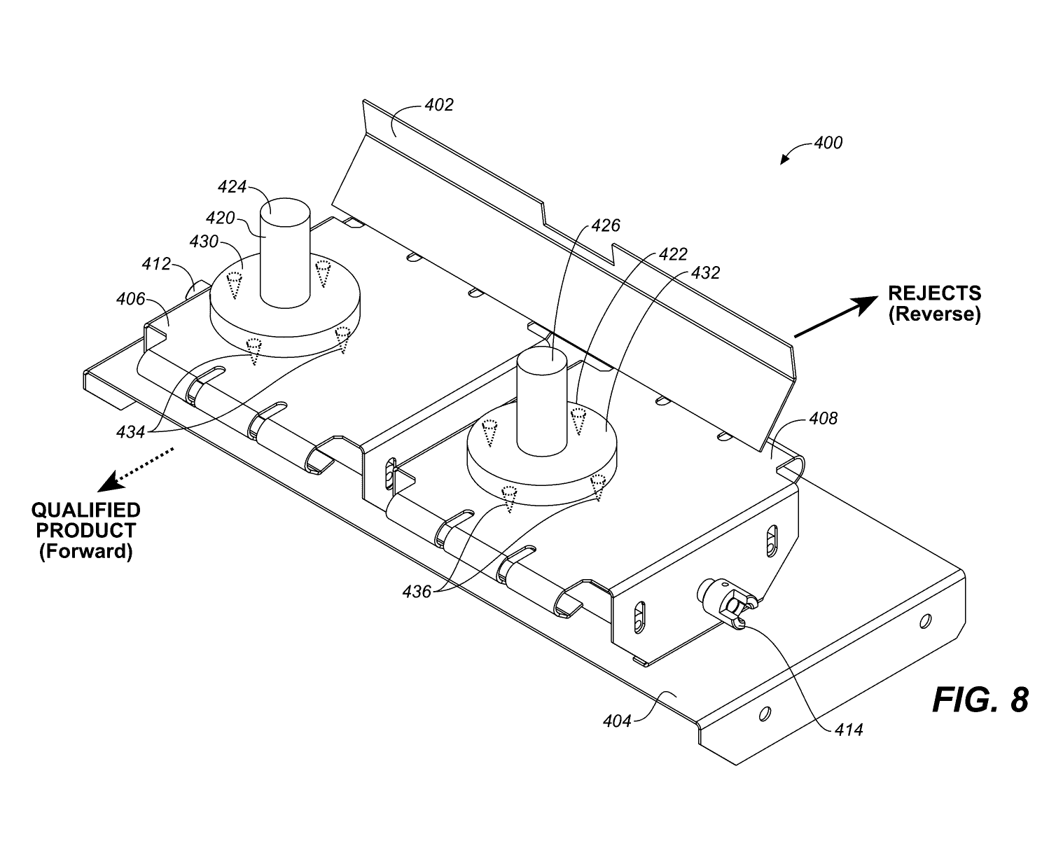

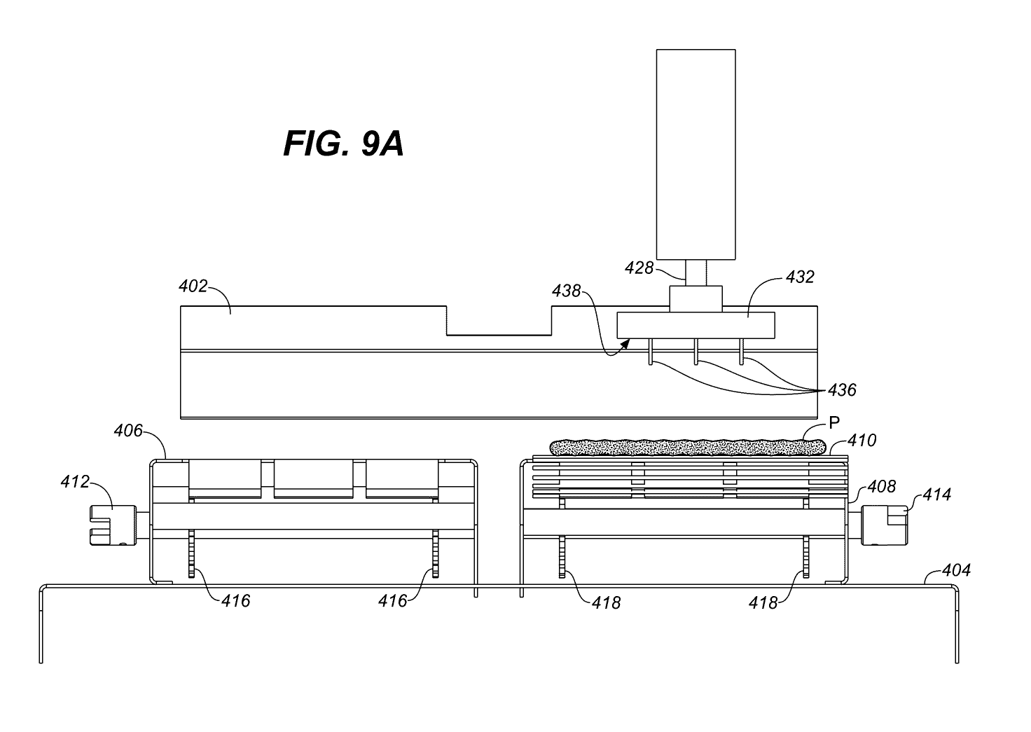

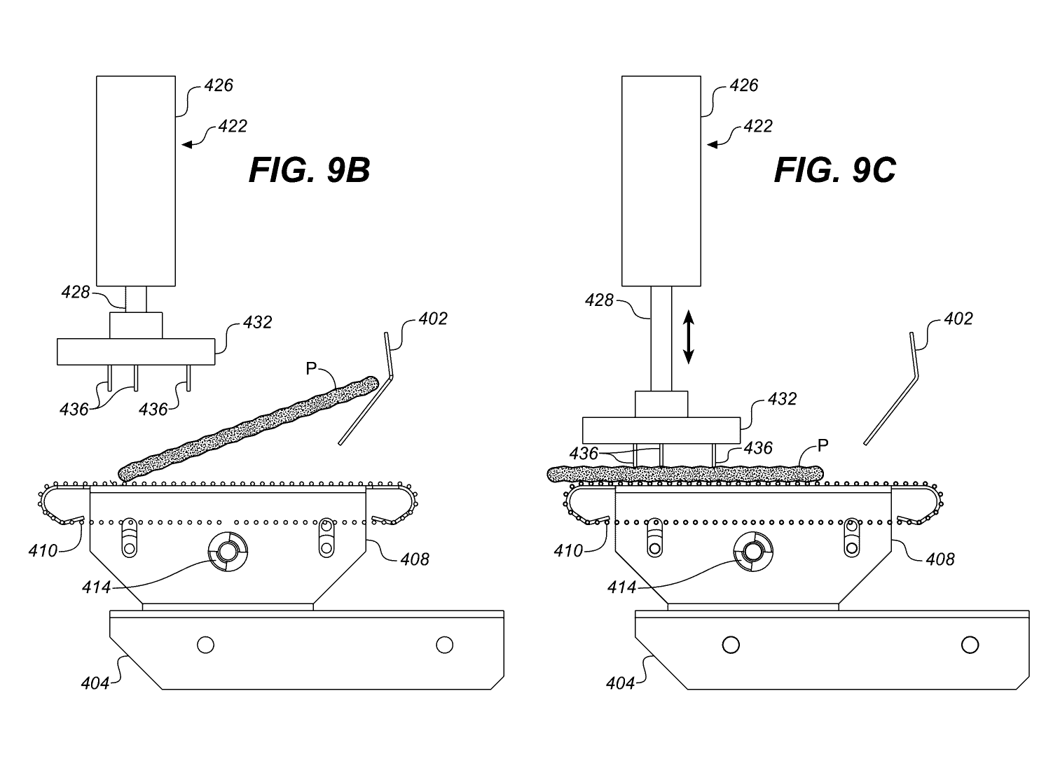

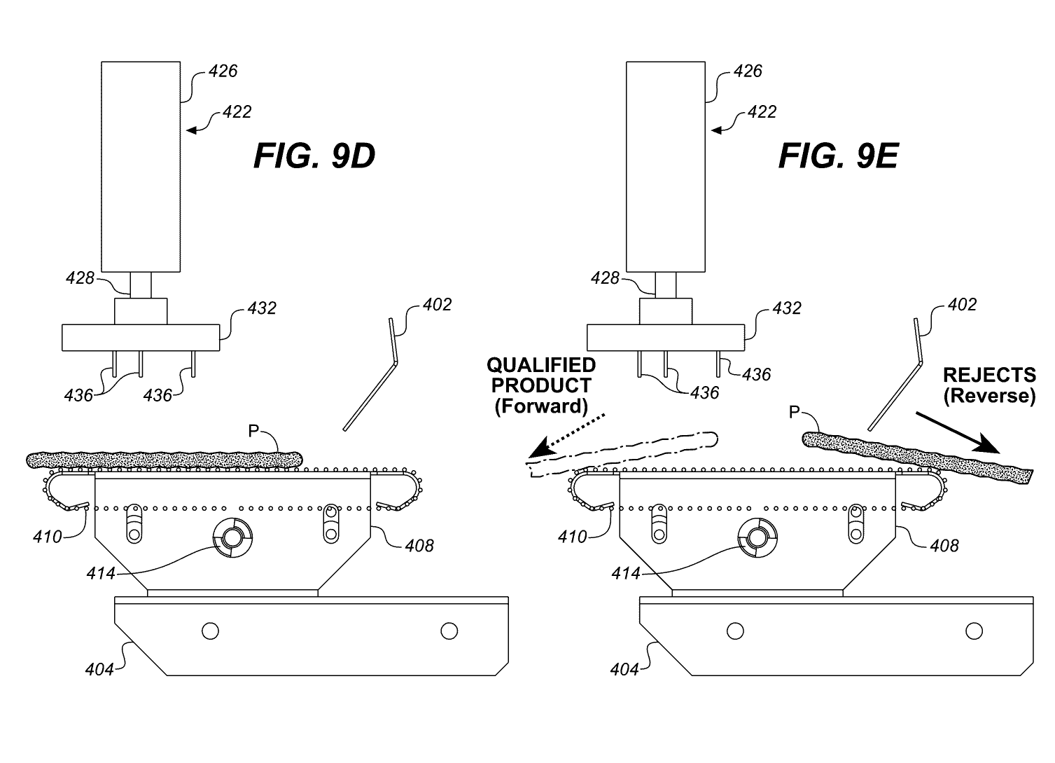

FIGS. 8-9E show the physical components of the HAACP (temperature feedback system) 400 of the present invention. FIG. 8 shows the system with several components removed for simplification. Here is it seen that a ramp 402 defines the end of the cooking chamber portion of the conveyor system and the exit belt portion 404. Conveyor belt lanes at the exit include belt platforms 406, 408, over which a wire belt 410 moves, driven by discrete belt motors (not shown) which drive the belts through axles 412, 414 and gearing 416, 418. Temperature probes 420, 422, each include an actuator 424, 426, or other motorized means, to drive a probe plunger shaft 428 (FIGS. 9A-9E) in a reciprocating motion (second plunger shaft not shown). The plunger shafts each have a plate 430, 432 on its end, the plate including a plurality of thermocouple needles or other penetrating sensors 434, 436 disposed on the underside 438 of the plunger head.

The qualification/rejection evaluation proceeds as described above, such that a cooked product P driven forward onto the exit belt 410 in FIG. 9B, is tested by probe 422 in FIG. 9C, the probe elevated and removed at FIG. 9D, and the conveyor motor then reversed by the PLC to reject the product and send it to the reject bin at FIGS. 9D-9E.

In an embodiment, the broiler may include three separate conveyor belt lanes. The above-described process logic and system control applies to the control of all lanes, wherein the same food product or different products may be cooked at the same time, possibly at different speeds depending on the food product. The freezer and product dispenser thus may include three cartridges, one feeding each lane. On a busy day at a restaurant, the same product may be loaded into multiple cartridges. The PLC recognizes cartridges of a particular product in a dispenser position in the freezer. Cooking and dispensing times will be controlled for optimal output. PID Broiler Temperature control will be moved from independent controller to a PCB when the PLC is replaced with a PCB.

In an embodiment, a first conveyor lane may be sized to accommodate two food product units side by side, and a second lane may be sized to accommodate only one. The lanes may have differential temperature control by providing more gas burners or manifolds in one lane relative to the other(s). In such an event, the lanes would also include different PIC controllers, air boxes, high are pressure blowers, and so forth. With such differential control and dedicated control apparatus, a user is able to turn off one lane to save energy. Loader and HAACP controls from the PLC are deactivated for the lane not in use.

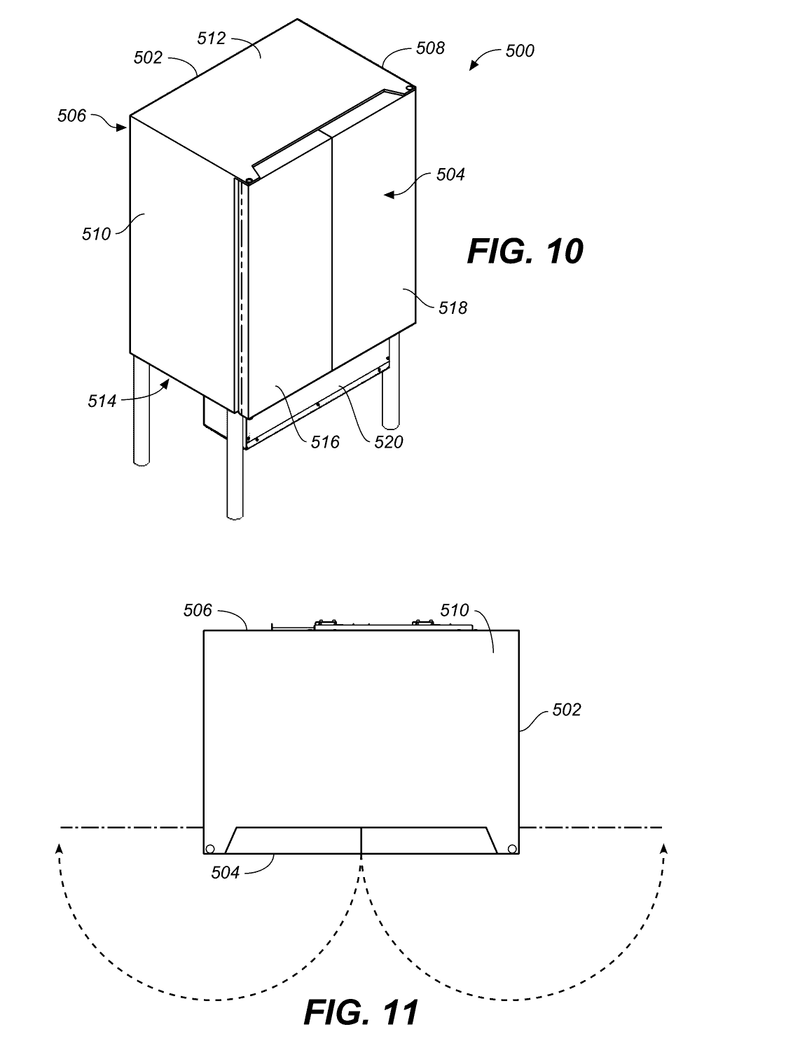

FIGS. 10-13B show an alternative product dispenser system and a freezer compartment therefor 500. In this alternative embodiment, the dispenser is again a food cartridge dispenser that dispenses products out a backside onto a loading chute and into the input end of the broiler 14 (FIGS. 1A-1B) and the input end of the conveyor belt 44 (FIGS. 1A-1B), as described above. In this instance, the freezer compartment is a cuboid box 502 having a front side 504, a rear side 506, a right side 508, and left side 510, a top side 512, and a bottom side 514. In a preferred embodiment, the front side of the compartment includes opposing right and left-handed doors, 516, 518, respectively. A dispenser motor housing 520 is disposed on the underside of the compartment.

Two or more side-by-side hollow product magazines 522, 524 may be disposed in a vertical orientation in the compartment interior so as to separate and feed, one at a time, the products 525 in a stack of food products (e.g., meat patties) 526, onto dispenser belts 528, 530 positioned below the corresponding magazine lower ends 532, 534. A motor drive 536 is enclosed by the motor housing and has a drive gear 538 operatively coupled to a driven gear 540 on the dispenser belts through a drive chain or drive belt 542. Each dispenser belt has a pusher bar 544 or other structure disposed on the upper side of the dispenser belt that engages food product at the bottom of the product stack 526 so as to slide product pieces, one-at-a-time, out from under the product stack and then push the product onto a discharge chute 546 that feeds into the product broiler for cooking.

The foregoing disclosure is sufficient to enable those with skill in the relevant art to practice the invention without undue experimentation. The disclosure further provides the best mode of practicing the invention now contemplated by the inventor.

While embodiments of the automated broiler and method herein shown and disclosed in detail are fully capable of attaining the objects and providing the advantages stated herein, it is to be understood that the embodiments are merely illustrative of the presently preferred embodiments of the invention and that no limitations are intended as to the detail of construction or design herein shown other than as defined in the appended claims. Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A food cooker, comprising:
a food product loader for dispensing uncooked food product;
a broiler having a food product inlet for receiving food product from said food product loader, a cooking chamber, a discharge end having a food product outlet for discharging cooked food product, a motorized conveyor system for conveying food through said broiler from said inlet end to said discharge end, and heating elements for heating and cooking food products in said cooking chamber;
a temperature sensor system that measures the internal temperature of cooked food product exiting said cooking chamber; and
a system controller in electronic communication with said temperature sensor system, said system controller programmed to receive and evaluate temperature readings from said temperature sensor system to qualify and disqualify cooked food products according to whether the readings obtained fall within or outside a predetermined temperature range.

2. The food product cooking system of claim 1, further including a discard bin and a holding bin, wherein said system controller directs disqualified food product to said reject bine and qualified food product to said holding bin.

3. The food product cooking system of claim 1, wherein said food product loader includes an automated product dispenser controlled by said system controller.

4. The food product cooking system of claim 3, wherein said food product loader includes magazines for storing stacked uncooked food product and a motorized drive system for dispensing discrete units of food product into said broiler.

5. The food product cooking system of claim 1, wherein said temperature sensor system includes a foot having a plurality of pointed temperature probes and an actuator for urging said probes into cooked food product.

6. The food product cooking system of claim 1, wherein said conveyor system comprises at least one motor driven conveyor belt.

7. The food product cooking system of claim 1, wherein said conveyor system includes a cooking chamber portion and an exit conveyor.

8. The food product cooking system of claim 7, wherein said temperature sensor system includes at least one temperature probe disposed above said exit conveyor and an actuator which drives said at least one temperature probe toward and into cooked food product.

9. The food product cooking system of claim 8, wherein said temperature sensor system further includes a proximity sensor which detects food product passing through said cooking chamber to said exit conveyor and sends a signal to said system controller, and said system controller is programmed to send a signal in response to the signal from said proximity sensor to said temperature sensor system to insert a temperature probe into the detected food product and analyze the product internal temperature.

10. The food product cooking system of claim 1, further including an input device for inputting a start signal to initiate a cooking cycle.

11. The food product cooking system of claim 10, wherein said input device is programmed to generate a product dispenser output signal that turns on a product dispenser motor in said product dispenser so as to start a cooking cycle.

12. The food product cooking system of claim 11, wherein said input device includes a broiler control component for controlling cooking cycle parameters.

13. The food product cooking system of claim 1, wherein said motorized conveyor system includes a cooking chamber portion and an exit conveyor, said exit conveyor portion controlled separately from said cooking chamber portion.

14. The food product cooking system of claim 13, further including a proximity sensor near said discharge end of said broiler, and wherein said system controller includes logic that detects when food product reaches said discharge end, whereupon said temperature sensor system introduces a temperature probe into the food product to take a temperature reading at a predetermined depth.

15. The food product cooking system of claim 14, wherein said system controller includes logic to direct movement of said exit conveyor belt in a first direction for qualified product if the temperature reading taken by said temperature sensor system falls within a predetermined range and in a second direction for discarded product if the temperature reading falls outside the same predetermined range.

16. The food product cooking system of claim 15, wherein said temperature sensor system includes a plurality of sensor needles disposed in a temperature probe plate.

17. The food product cooking system of claim 15, wherein said system controller is programmed to generate signals to said exit conveyor to discharge tested food product in a direction depending on the sensed temperature.

18. The food product cooking system of claim 17, wherein said system controller includes logic that recognizes the occurrence of rejects so as to ensure that a preselected number of final cooked and qualified products is achieved.

19. The food product cooking system of claim 17, wherein said system controller is programmed to analyze temperature data points from said temperature sensor system, and if the temperature data points fall outside a dynamic set point range, said system controller increases or decreases product recipe cook time by either slowing down or speeding up said cooking chamber portion of said motorized conveyor system.

20. The food product cooking system of claim 17, wherein said motorized conveyor system includes a plurality of conveyor belts and exit conveyor belts, each independently controlled by said system controller, such that food product cooking times and exit conveyor belt directions are controlled independently of the other of said conveyor belts.

21. The food product cooking system of claim 20, wherein said motorized conveyor system includes a plurality of cooking lanes, each having a chamber portion conveyor belt and an exit conveyor, and each having independently controlled heating elements, such that said motorized conveyor system and said heating elements in any one of said plurality of cooking lanes may be selectively turned off to save energy while others remain operating.
